(19) United States
(12) Patent Application Publication
(10) Pub. No.: US 2019/0031244 A1
(43) Pub. Date: Jan. 31, 2019

(54) Compartmented vehicular firewall bulkhead

(71) Applicant: William Joseph Riffe, Beaufort, NC (US)

(72) Inventor: William Joseph Riffe, Beaufort, NC (US)

(21) Appl. No.: 15/731,755

(22) Filed: Jul. 28, 2017

(51) Int. Cl. B62D 25/08; B62D 21/15; B62D 29/00

(52) U.S. Cl. CPC B62D 25/082; B62D 29/008; B62D 29/007; B62D 21/152

(57) ABSTRACT

An improved automotive firewall bulkhead system comprising:

(a) a multi compartmented, metallic firewall bulkhead that separates the engine bay from the passenger compartment and that salvages heat and energy from the engine bay: and

(b) firewall bulkhead compartments in which are enclosed both vehicular heating and cooling components, removed from spaces in other more useful sites within the engine bay and passenger compartment: and

(c) structural compartments that, in the event of a collision, enhance the destructive energy absorbing, metallic crumpling action of the engine bay while inhibiting the spread of any fire into the passenger compartment.

### BACKGROUND OF THE INVENTION

### 1. Field of the Invention

The present invention relates generally to a specific type of automotive, structural bulkhead located, in most contemporary vehicles, so that the bulkhead separates the passenger compartment from the engine bay.

### 2. Discussion of the Background Art

The adoption by the early automotive industry of the term firewall is analogous to the term commonly used to describe a bulkhead or wall interposed between various sorts of fixed architectural structures to prevent the spread of unintended fire, or other disturbances, from one structure to another. Such was a similar intention when early vehicles possessed engines and engine bays that were prone to fires that were often lethal for operators and occupants of the vehicles.

Said vehicular firewall bulkheads were, for long and are still, generally comprised of a single sheet of cold rolled steel. Drawing impresses the necessary curves and angles for the firewall to be interposed between the engine bay and passenger compartment. Each model of vehicle still requires a specific firewall bulkhead configuration that is usually installed transversely in the vehicle from right door post to left door post and vertically from floor pan to windshield frame.

Most present day vehicles are propelled by power derived from petroleum burning, internal combustion engines. Internal combustion engines do not convert all of their fuel to useful energy. Some of the heat of combustion and frictional heat within the engine is simply discharged into the engine bay and lost to its intended vehicular use. Industrially, this is ‘waste heat.’ A desirable innovation is one wherein an existing vehicular component is made to perform additional and previously unrelated functions. One such desirable innovation is to produce and install a vehicular firewall bulkhead that captures and utilizes automotive waste heat and simultaneously provides improved, mechanically derived, crash protection for the vehicle.

### SUMMARY AND OBJECTS OF THE INVENTION

Accordingly, one object of the present invention is an improved type of vehicular firewall bulkhead that will extract and utilize waste heat and energy from hot fumes and gasses in an operating vehicle engine bay to provide heated air for distribution to various other vehicle compartments.

Another object of the present firewall invention is to compartmentalize the structure of the firewall bulkhead invention so as to cause it to both increase the rigidity of the vehicle shell, and provide a crushable, energy dispersing structure between the engine bay and the other vehicle compartments. These and other objects have been satisfied by the discovery of an improved firewall bulkhead structure comprising:
(a) a firewall bulkhead with a front compartment that absorbs heat from the hot fumes and gasses of the engine bay that impinge upon the front, exterior wall, of the firewall bulkhead during operation of the vehicle engine and an inclusion therein of an auxiliary heater coil supplied with heated coolant fluid from the engine through hoses, valves and controls attached to the engine cooling fluid system; and
(b) having a rear compartment, similar in configuration to the front, but instead of producing heated air an evaporation coil provides chilled air to the vehicular air handling system: and
(c) incorporation of the air heating and air chilling coils within the firewall structure to reduce the obtrusive space occupied by their usual dashboard and engine bay mounting locations; and
(d) by enclosing the metal supplementary air heating coil within the firewall chamber it is possible to simplify its' fluid flow path and thereby reduce heating system leakage caused by oxygen cell corrosion; and
(e) constructing the firewall invention as unitized compartments will provide a structure that crumples metal by stages, to absorb and disperse energy generated in a collision.

### BRIEF DESCRIPTION OF THE FIGURES

Further advantages and features will become apparent from reading the following description, provided in more detail, by referring to the accompanying drawings in which:

FIG. 1 is a diagrammatic illustration of the placement of the firewall bulkhead and compartments in a typical automotive vehicle.

FIG. 2 is a right hand, perspective view, of the firewall bulkhead invention.

FIG. 3 is a left hand, expanded perspective view, of the three walls, and their relative positions, that constitute said firewall bulkhead invention.

FIG. 4 is a rear view, perspective cut away of the firewall bulkhead invention exposing the positioning of the two compartments, with installed conduit units and auxiliary heater.

FIG. 5 is a diagrammatic front view of a typical, firewall placement in a contemporary automobile.

FIG. 6 is a front elevation view of the front panel blank with flanges and various punch-outs.

FIG. 7 is a perspective view of a semiperferate, rooftop, half shear, self fixturing knob.

FIG. 8 is a diagrammatic illustration of hot fumes and gasses pathways through a vehicular engine bay and impinging upon the automotive firewall bulkhead.

FIG. 9 is a diagrammatic illustration of warm air from the firewall bulkhead passing through dashboard vents into the vehicle passenger compartment.

FIG. 10 is a right hand perspective view of the rear side of the, center wall blank with a surface metal peel exposing the honeycomb structure and penetrating conduits.

FIG. 11 is a right hand, perspective of the rear face of the rear wall with access holes punch-out openings, rear panel hatch cover and transmission tunnel opening.

### REFERENCE NUMERALS OF THE FIGS.

1. engine bay

2. passenger compartment

3. firewall bulkhead

4. front wall

5. center wall

6. rear wall

7. perimeter edge wall

8. front compartment

9. rear compartment

10. heating coil

11. cooling coil

12. door post

13. floor pan

14. windshield seat

15. flanges

16. access holes

17. corner punch outs

18. auxiliary heater opening

19. single hem fold

20. transmission tunnel

21. corner seam welds

22. air handling flow

23. front wall hatch cover

24. conduit

25. doubler

26. metal honeycomb

27. rear hatch opening

28. transmission tunnel closure

### DETAILED DESCRIPTION OF THE PREFERRED EMBODIMENTS

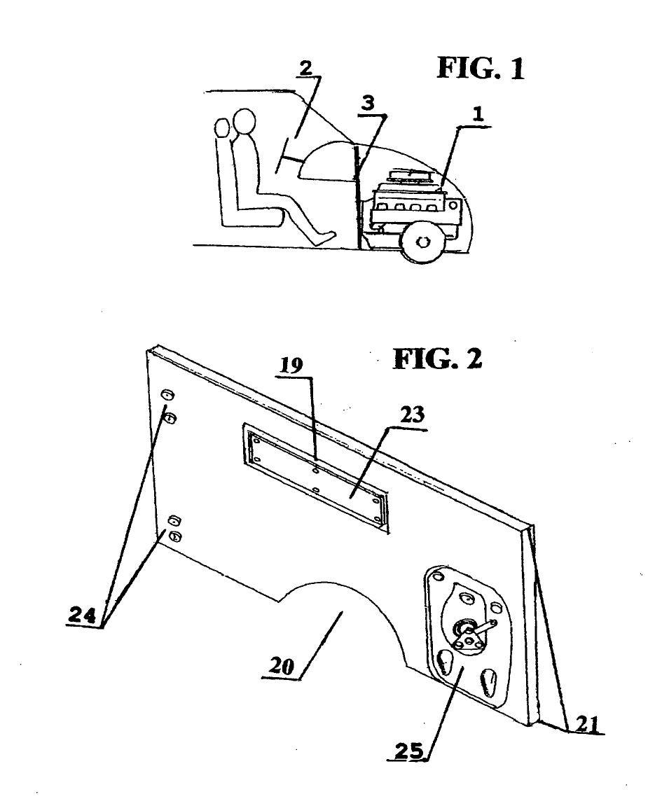

The majority of contemporary vehicles FIG. 1 are divided into a front section, where the engine is located, termed the engine bay 1, and a rear section, termed the passenger compartment 2. They are separated by a bulkhead, 3, consisting of a single thickness of press formed sheet metal termed a firewall bulkhead. Said firewall bulkhead 3 forms the rear wall of the engine bay 1 and the front wall of the passenger compartment 2.

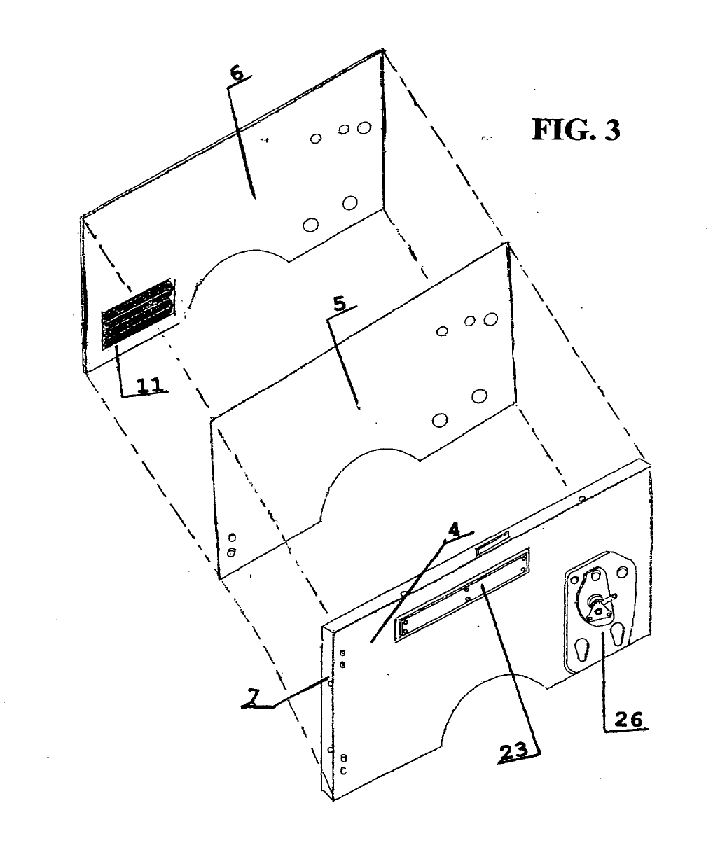

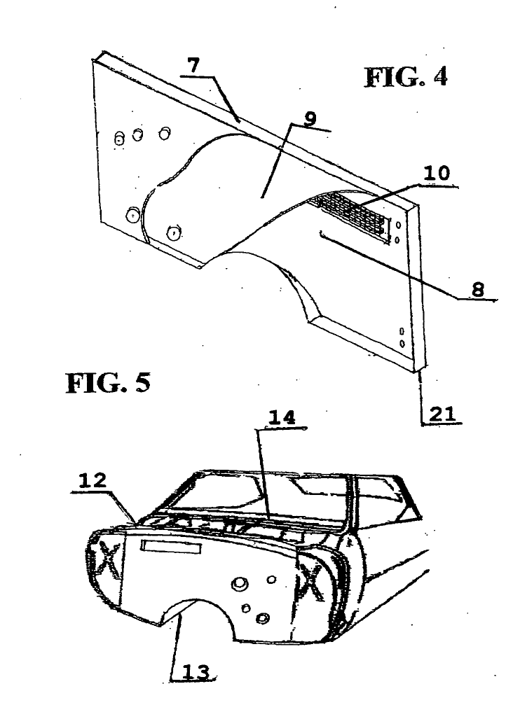

Said firewall bulkhead invention FIG. 2 is a metallic, right rectangular parallelepiped, irregular boxlike structure FIG. 3 constructed of four metal walls: front wall 4, center wall 5 and rear wall 6, enclosed by a surrounding perimeter edge wall 7. A cut away view FIG. 4 from the rear of the firewall bulkhead invention illustrates the four walls in place, and reveals that the four walls form two compartments; the front compartment 8, immediately to the rear of the engine and the rear compartment 9, that is in front of the passenger compartment 2. The complete assembly thickness, from front to rear, is sufficient to enclose a metal heating 10 or cooling coil 11 longitudinally in each compartment.

Said present firewall bulkhead invention FIG. 2 is constructed of steel or aluminum. The front wall 4, of the firewall bulkhead FIG. 2, is the basis of the structure upon which the center wall 5 and rear wall 6 are erected. It is of a size to fit in the space of a conventional firewall bulkhead FIG. 5 of the particular vehicle for which the firewall bulkhead invention FIG. 2 is intended.

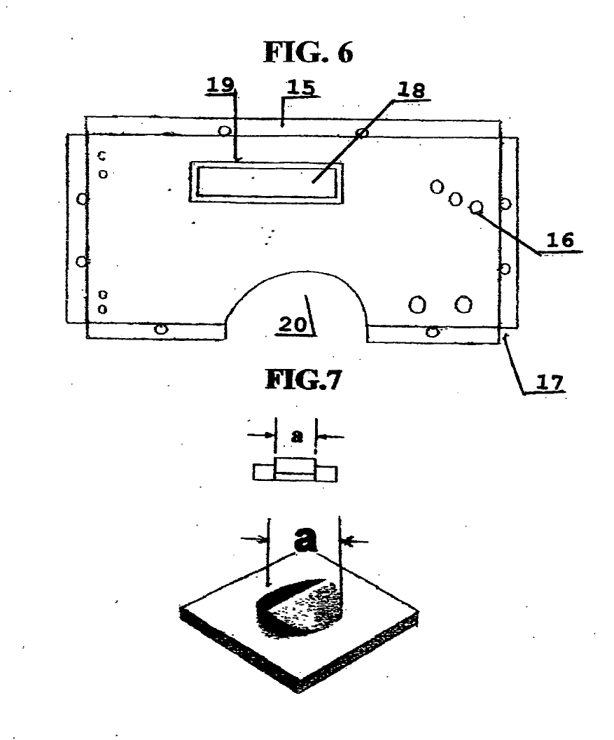

The metal selected for the front wall blank FIG. 6 is sheared from a sheet metal source that is somewhat wider than the widths of the other two blanks and sheared; again somewhat longer than the lengths of the other two blanks. The greater width and length will provide the extra material necessary to construct flanges 15 on the front wall blank FIG. 6. The sheet metal, thus sheared for the front wall blank, FIG. 6 is punched to provide access and ventilation holes 16 and other required features. A square 17 is sheared out of each corner of the blank FIG. 6 that is the same width on each edge as the desired width of the flanges 15. This results in rather narrow flanges 15, extending fully and independently, along all four sides of the blank FIG. 6.

Said flanges 15, after pressing to an angle of 90 degrees to the plane of the blank FIG. 6, constitute the perimeter edge walls 7 of the assembly. Along the length of each flange 15, with equidistant spacing and centered between the outer edge and the bend, there are punched two or more, semi perforate, rooftop, half shear knobs FIG. 7. They are pressed to protrude slightly through the perimeter edge walls 7 into the front compartment and serve as self-fixturing locators for installing the center wall 5. Also, a relatively narrow rectangular opening 18, is sheared in the front wall blank FIG. 6 to accommodate the installation of a supplementary heater coil 10 within the front compartment 8. All edges of sheared openings, throughout said firewall bulkhead, are single hemmed 19 to provide both rigidity to the walls 4, and a foundation for closure fasteners.

Lastly, in rear wheel drive model vehicles, a large semicircular portion is removed from the center of the bottom edge of all three blanks, in order to provide a transmission tunnel 20, passing rearward from the engine bay 1 at final assembly. When blanking and forming of the front wall blank FIG. 6 is complete, and the corner seams 21 are welded closed, the essential, box like structure of the front wall 4 is complete. It only remains to install the final two walls and their associated components to complete said firewall bulkhead structure. FIG. 2

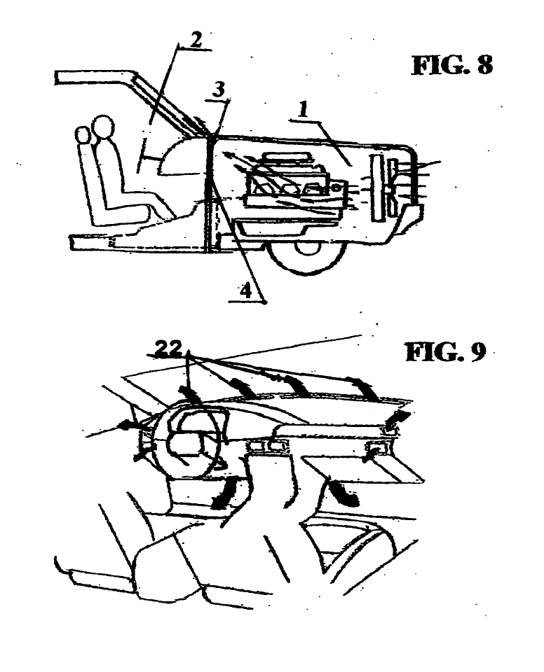

The front wall 4 of said firewall bulkhead FIG. 2 is the rear wall of the vehicle engine bay 1. That wall 4 is swept and heated by hot fumes and gasses FIG. 8 produced by the internal combustion engine situated within the engine bay 1. Thereby, the front wall 4 of the firewall bulkhead FIG. 2 absorbs heat and radiant energy from the hot fumes, gasses and many points of radiation within the engine bay. 1. Such heat and radiant energy is transferred by conduction through the metal of the front wall 4 to heat, by convection, the air within the front compartment 8.

To provide additional heat within the front compartment 8, a supplementary heater coil 10 is included within said compartment 8. Said heater coil 10 is connected to the vehicle engine cooling fluid system in such a manner that heated engine coolant is directed through the coil 10 as required. The inclusion of the heater coil 10 will disrupt the flow of air being introduced for heating within the front compartment 8 and cause turbulent air scrubbing of the heated interior surfaces of the front compartment 8. Such contact of turbulent air with the heated walls of the front compartment 8 will, by convection, increase the temperature of said air.

Because the firewall bulkhead invention FIG. 2 is configured specifically for each make, model and type of automobile or truck for which it is intended all access and ventilation holes 16 are located variously in the firewall bulkhead FIG. 2 from front to rear and through the perimeter edge walls 7. Said access holes 16 allow the passage of various operational controls from the passenger compartment 2 into the engine bay 1. The ventilation holes, of the perimeter edge walls, 7 allow the passage of heated or chilled air from within the firewall FIG. 2 into the vehicular air handling system 22 specific to that automobile or truck.

In order to provide the required clean, heated or chilled, air flow from within the firewall bulkhead FIG. 2 there must be no admission of contaminating hot fumes and gasses from the engine bay 1 to the interior of the firewall FIG. 2. To reduce the likelihood of engine bay 1 hot fumes and gasses leaking through walls at multiple, access holes, 16 where various types of control rods, levers, cables and such items pass through the firewall bulkhead FIG. 2, there are installed, instead of gaskets, rigid metal conduits, 24.

Where each conduit 24 passes through the front 4 and rear 6 walls there is welded externally onto the wall, surrounding the conduit, a metal doubler 25 to stiffen the firewall bulkhead FIG. 2. The conduits 24 are installed by gas tight welding of each segment into appropriate wall access holes 16 for passage of control mechanisms from the front wall 4, through the rear wall 6 and into the passenger compartment 2. Such conduit 24 weldments not only limit the entry of hot fumes and gasses into the firewall bulkhead FIG. 2 but also add to the rigidity of the structure.

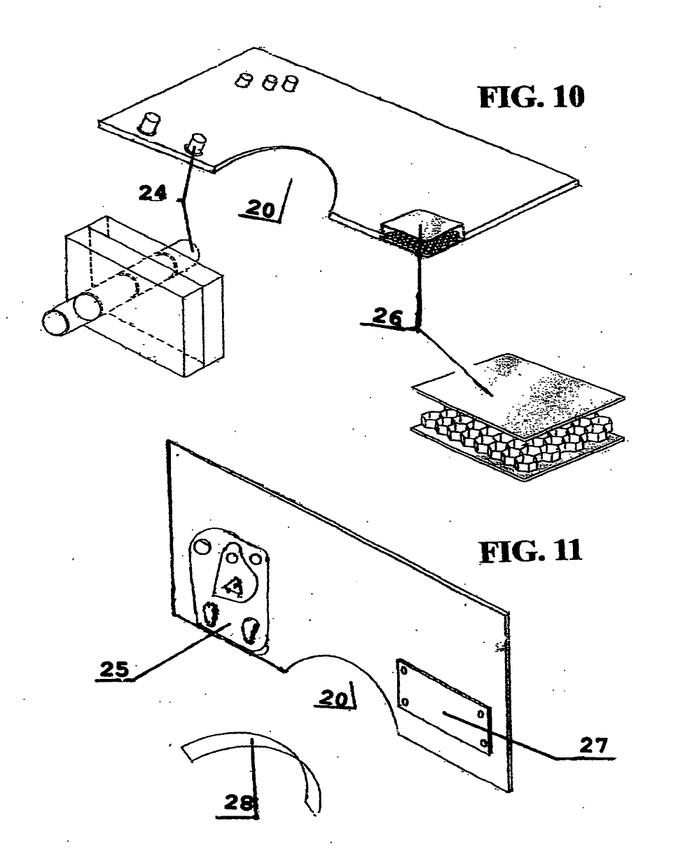

For each of the compartments to function efficiently there must not be physical contact such that heat from the front compartment 8 might be transmitted to the cooler functioning rear compartment 9. Therefore, the center wall blank FIG. 10 is formed of a thin, metal, honeycomb type of 26 insulating board separating the two. The profile of the center wall blank mimics that of the front wall blank FIG. 6 except that there are no flanges 15 and the steering column and brake pedal access holes 16 are slightly further up the blank as compared to that of the front wall. At assembly the center wall 5 is fitted tightly within the front compartment, 8 seated upon the semi perforate half shear knobs FIG. 7 and welded, gas tight, to the perimeter edge wall 7.

The final phase of the firewall bulkhead assembly will begin by blanking and installing the rear wall 6 into the assembly and closing the transmission tunnel 20. In the final blanking of the rear wall 6 the access holes 16 are punched out and a rectangular rear hatch opening 27 is sheared, through which the vehicular cooling, coil 11 will be installed within the rear chamber 9. to provide cooling air, instead of heat. A length of metal cooling coil 11, to serve as an evaporator core for an air chilling system, is installed. Said evaporator coil 11 is connected, via suitable hoses, valving and controls to a refrigerant compressor system means within the engine bay 1.

The rear wall 6 is welded snugly flush, within the rear compartment 9 perimeter edge wall 7, at the extreme rear and with all conduit 24 firmly welded, gas tight, in their respective holes. 16 When the rear wall 6 is completely installed it is time to complete the major structure of the firewall invention by closing the transmission tunnel 20. This is done by roll forming a small, rectangular piece of sheet metal 29 from the same metal stock as the firewall FIG. 1 and welding it into the transmission tunnel 20 to each of the bottom edges of all three walls. This action effectively closes each compartment of the firewall.

Additionally, the subject firewall bulkhead invention FIG. 2 disperses the destructive energy entering the engine bay in the event of a collision. The compartmented, relatively rigid structure, of the bulkhead firewall FIG. 2 adds to the ability of the engine bay 1 to disperse impact energy by crumpling the metal of said bulkhead FIG. 2 rather than fully transferring collision energy from the engine bay to the other compartments 2. The same chambered metal structure also provides additional insulation value so as to reduce injurious heat and or fire in the engine bay 1 from entering other compartments 2.

Obviously, numerous modifications and variations of the present invention are possible in light of the above teachings. It is therefore to be understood that within the scope of the appended claims, the invention may be practiced otherwise than as specifically described herein.

What is claimed as improved and desired to be secured by Letters Patent of the United States is:

1. An improved, automotive firewall bulkhead system that separates the passenger compartment from the engine bay, disperses collision impact forces, deflects hot fumes and gasses within the engine bay and which improvements comprise:
(a) substantially, a right rectangular parallelepiped, box-like compartment, configured to fit within a designated automotive firewall location, with metal walls pierced by ventilation ports and vents, enclosed and unitized by a metal perimeter edge wall, which delimits planar parameters of the assembly and determines the circumferential profile of the irregular firewall bulkhead; and
(b) further comprises siting of said firewall bulkhead within the automotive structure so that the front wall of the firewall bulkhead constitutes the engine bay rear wall that is swept and heated by the hot fumes and gasses that swirl within an operating automotive engine bay.

2. The system of claim 1, wherein said metal structure is comprised of a metal selected from a group consisting of ferrous and non-ferrous metals.

3. The system of claim 2, comprised of the ferrous metal, steel.

4. The system of claim 2 comprised of the non-ferrous metal aluminum.

5. The system of claim 1, wherein the firewall bulkhead is comprised of metal components so assembled and fastened that, in the event of a collision, impact forces are dispersed by metal deformation of the firewall bulkhead structural members.

6. A method comprising the transfer of heat from the engine bay by conduction through the metal front wall of said firewall bulkhead, that is swept and heated by hot fumes and gasses that swirl within an operating automotive engine bay and that heat, by said conduction, the rear face of the front wall of the firewall bulkhead.

7. The method of claim 6 comprises heating by convection, of air introduced within the compartmented firewall bulkhead through air ventilation ports, and contact of said air with the hot metal convector of the rear, interior surface, of the front wall of said firewall bulkhead and which heated air is vented from the firewall bulkhead for other applications.
